(19) United States
(12) Patent Application Publication
(10) Pub. No.: US 2020/0028400 A1
(43) Pub. Date: Jan. 23, 2020

(54) COIL WIRING UNIT OF DRIVE MOTOR FOR VEHICLE AND MANUFACTURING METHOD THEREOF

(71) Applicants: Hyundai Motor Company, Seoul (KR); Kia Motors Corporation, Seoul (KR)

(72) Inventors: Young-Jin Seo, Gyeonggi-Do (KR); Yeon-Ho Kim, Gyeonggi-do (KR); Ga-Eun Lee, Gyeonggi-do (KR); Jae-Min Yu, Incheon (KR); Hee-Ra Lee, Gyeonggi-do (KR); Myung-Kyu Jeong, Seoul (KR)

(21) Appl. No.: 16/213,345

(22) Filed: Dec. 7, 2018

(30) Foreign Application Priority Data
Jul. 17, 2018 (KR) 10-2018-0082987

(51) Int. Cl. H02K 3/52; H02K 3/38; H02K 15/00; H02K 15/10; H02K 15/12

(52) U.S. Cl. CPC H02K 3/522; H02K 3/38; H02K 2203/09; H02K 15/10; H02K 15/12; H02K 15/0062

(57) ABSTRACT

A coil wiring unit of a drive motor for a vehicle is provided. The unit includes a bus bar assembly that has a plurality of bus bars for connecting coils of the drive motor to each phases stacked in a longitudinal direction. A plurality of insulating sheets are disposed between each of the bus bars and correspond to the shape of each of the bus bars.

### CROSS-REFERENCE(S) TO RELATED APPLICATIONS

This application claims priority to Korean Patent Application No. 10-2018-0082987, filed on Jul. 17, 2018 which is incorporated herein by reference in its entirety.

### BACKGROUND

### Field of the Disclosure

The present disclosure relates to a coil wiring unit of a vehicle drive motor and manufacturing method thereof, and more particularly, to a coil wiring unit of a vehicle drive motor vehicle and manufacturing method thereof for simplifying the number of parts and manufacturing process by forming an integrated module through an insert molding after inserting and attaching an insulating sheets between each bus bar in forming and stacking an annular bus bar having the same inner/outer diameter based on the concentric axis for each phase in the concentric winding type drive motor.

### Description of the Related Art

Generally, the method of winding a coil in a drive motor may be divided into distributed winding and concentrated winding. The distributed winding is a method of winding the coil by dividing the coil into two or more slots, and the concentrated winding is a method of concentrating the coil on one slot and winding it. However, the concentrated winding type three-phase drive motor requires a separate coil wiring structure that connects the coils drawn out from each split core to three phases (i.e., U-phase, V-phase, W-phase) and neutral point (i.e., N-phase).

With regard to the coil wiring structure, a developed technology in the related art teaches a structure in which a U/V/W/N-phase bus bar made of an annular conductor is formed and inserted into an annular holder for overmolding. Particularly, due to the characteristic that high voltage is applied, the bus bars of each phase should be electrically insulated from each other, so that a spacer of insulating material is separately provided between the bus bars. In particular, the process characteristic of injection and molding may lead to a weakening of the insulation performance, since unfilled portions due to unformed or foreign material, and the like may exist. The drive motor to which a high voltage is applied may cause an inter-phase short-circuit and motor burnout.

The weakening of the insulation performance may be confirmed from the limit withstand voltage level through the internal voltage breakdown test. For example, in the case of normal products, the limit withstand voltage level is 3.5-3.7 kV level, while when non-molded or unfilled parts are exist, it is 2.4-2.7 kV so that the insulation performance is decreased up to 37.2% compared to normal products.

The conventional annular bus bar is disposed on a concentric circle in a radial direction (i.e., transverse direction) to secure spacer assembly and to apply overmolding. In particular, since the sizes (i.e., inner/exterior diameter) of the bus bars are different for each phase, each bus bar mold is required for each phase. Further, the thicknesses of the bus bars are also determined by the output of the drive motor. However, if the thickness of any one bus bar is changed, since the inner and outer diameters of the remaining bus bars also need to be changed, a new bus bar mold is required to be produced each time for a new drive motor.

In addition, since the structure of disposing the bus bars of the same cross-section area in the transverse direction requires that the thickness of the U-phase bus bar of the innermost part should satisfy the current specification (same current on the actual U/V/W-phase), and the diameters of bus bars of V-phase and W-phase should be increased while maintaining the same thickness, an unnecessary cost increase occurs. Since the bus bar material is copper, as the length increase, the electrical resistance increases. Therefore, the coil wiring structure requires measures to solve the problems arising from the fact that the bus bars of each phase provide an insulating structure and the size of the bus bars on each phase is different by phase.

The foregoing is intended merely to aid in the understanding of the background of the present disclosure, and is not intended to mean that the present disclosure falls within the purview of the related art that is already known to those skilled in the art.

### SUMMARY

The present disclosure provides a coil wiring unit of a drive motor for a vehicle and manufacturing method thereof for simplifying the number of parts and manufacturing process by forming an integrated module through an insert molding after inserting and attaching an insulating sheet between each bus bar in forming and stacking an annular bus bar having the same inner/outer diameter based on the concentric axis for each phase in the concentric winding type drive motor.

A coil wiring unit of a drive motor for a vehicle according to an exemplary embodiment of the present disclosure may include a bus bar assembly of which a plurality of bus bars for connecting coils of the drive motor to each phases are stacked in a longitudinal direction; and a plurality of insulating sheets which correspond to the shape of each of the bus bars of the bus bar assembly and disposed between each of the bus bars of the bus bar assembly.

Each of the bus bars of the bus bar assembly may be an annular structure having the same inner/outer diameter based on the concentric axis. Each of the bus bars of the bus bar assembly may be a conduct plate of copper material made through press process. Each of the bus bars of the bus bar assembly may include a connecting piece that connects the coils of the drive motor to each phase. The connecting piece may include a protruded portion that protrudes from each of the bus bars of the bus bar assembly in a longitudinal direction; a bent portion bent from an end portion of the protruded portion in a transverse direction; and a groove portion having a “U”-shaped groove at the bent portion.

The protruded portion may have a different position to be connected to each of the bus bars of the bus bar assembly based on each phase and a different protruding length based on each of the bus bars of the bus bar assembly. The area of each of the plurality of insulating sheets may be greater than or equal to the area of each of the bus bars of the bus bar assembly. Each of the plurality of insulating sheets may be a NOMEX, PEEK (PolyEther Ether Ketron), NPN (Nomex-Polyester-Nomex) series film.

The bus bar assembly and the plurality of insulating sheets may all be stacked and then integrally formed through in insert molding. Each of the bus bars of the bus bar assembly and each of the plurality of insulating sheets may be stacked individually and then formed as an individual molding product through an insert molding; and each of the individual molding product may be stacked as one piece to be assembled. Each of the plurality of insulating sheets may be attached to each of the bus bars of the bus bar assembly using an adhesive.

A manufacturing method of a coil wiring unit of a drive motor for a vehicle according to an exemplary embodiment of the present disclosure may include forming a bus bar assembly of which a plurality of bus bars for connecting coils of a drive motor to each phase are stacked in a longitudinal direction, and a plurality of insulating sheets which correspond the shape of each of the bus bars of the bus bar assembly shape and disposed between each of the bus bars of the bus bar assembly; stacking the bus bar assembly and the plurality of insulating sheets; and stacking the bus bar assembly and the plurality of insulating sheets and then integrally molding through an insert molding.

A manufacturing method of a coil wiring unit of a drive motor for a vehicle according to another exemplary embodiment of the present disclosure may include forming bus bar assembly of which a plurality of bus bars for connecting coils of a drive motor to each phase are stacked in a longitudinal direction, and a plurality of insulating sheets which correspond the shape of each of the bus bars of the bus bar assembly shape and disposed between each of the bus bars of the bus bar assembly; stacking the bus bar assembly and the plurality of insulating sheets individually and then forming an individual molding product through an insert molding; and stacking each of the individual molding product to one piece to assemble it. The stacking of the bus bar assembly and the plurality of insulating sheets may include attaching each of the plurality of insulating sheets to each of the bus bars of the bus bar assembly using an adhesive.

The present disclosure may reduce and simplify the number of parts and manufacturing process by forming an integrated module through an insert molding after inserting and attaching an insulating sheet between each bus bar in forming and stacking an annular bus bar having the same inner/outer diameter based on the concentric axis for each phase in the concentric winding type drive motor. Further, the present disclosure may reduce cost by the reduction of original material volume by minimizing the injection volume due to spacer and overmold removal.

Furthermore, the present disclosure may reduce manufacturing costs by eliminating manufacturing processes such as hand-held processes of bus bars and spacer assemblies and holder press fitting, and the like, and inspection processes to detect defects of injection molding product. In addition, the present disclosure may produce four types of parts with one mold since the cross section of each bus bar is the same. If the motor specification is different, the thickness of the coil wiring unit may be changed by changing the thickness of the input material to minimize the production of molds even for a substantial number of vehicle types.

In other words, the present disclosure may reduce the investment cost through component sharing. In addition, the present disclosure may reduce the weight of an injection molding product using an insulating sheet. The present disclosure may reduce the size (overall length) of the drive motor by replacing the injection molding product (i.e., spacer) for insulation between bus bars using insulating sheets. In addition, the present disclosure may improve the insulation performance between each bus bar using an insulating sheet and improve insulation endurance quality of the drive motor by eliminating injection defects (pore/unfilled, etc.) occurring in the injection process.

### BRIEF DESCRIPTION OF THE DRAWINGS

The above and other objects, features and advantages of the present disclosure will be more clearly understood from the following detailed description taken in conjunction with the accompanying drawings, in which:

FIG. 1 is a drawing showing the coil wiring unit of a drive motor for a vehicle according to an exemplary embodiment of the present disclosure;

FIG. 2 through FIG. 5 are cross sectional views taken along A-A′ in the coil wiring unit shown in FIG. 1 according to an exemplary embodiment of the present disclosure;

FIG. 6 is a cross sectional view in a state of installing the coil wiring unit of FIG. 1 on the drive motor according to an exemplary embodiment of the present disclosure; and

FIG. 7 is a drawing illustrating a manufacturing method of the coil wiring unit of the drive motor for the vehicle according to an exemplary embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter, exemplary embodiments of the present disclosure will be described in detail with reference to the accompanying drawings. However, detailed descriptions of known functions or configurations that may obscure the gist of the present disclosure in the following description and attached drawing will be omitted. Further, it should also be noted that throughout the drawing the same constituent elements are represented by the same reference numeral as possible. Terms and words used in this specification and claims scope below are not to be construed as limited to ordinary or dictionary meanings, and the inventor should interpret the invention in terms of meaning and concept consistent with the technical idea of the present disclosure based on the principle that it can properly define its own invention as a term for describing it in the best way. Therefore, the configurations shown in the exemplary embodiments and drawings described in this specification are merely the most preferred embodiment of the present disclosure and are not representative of the technical ideas of the present disclosure, so that it should be understood that various equivalents and modifications may be substituted for those at the time of filing of the present application.

In the accompanying drawings, some constituent elements are exaggerated, omitted or schematically illustrated, and the size of each constituent element does not entirely reflect the actual size. The present disclosure is not limited by the relative size or spacing drawn in the accompanying drawing. Also, when a part is “connected” to another part, the element may be “directly connected” to another part as well as “electrically connected” to another part with other element therebetween.

Hereinafter, the present disclosure will be described in detail so that a person skilled in the art can easily carry out an exemplary embodiment of the present disclosure by referring to accompanying drawing. However, the present invention may be embodied in many different forms and is not limited to the embodiments described herein. In order to clearly illustrate the present invention, parts not related to the description are omitted, and like parts are denoted by like reference numerals throughout the specification. Hereinafter, referring to the drawings, the preferred exemplary embodiments of the present disclosure will be described.

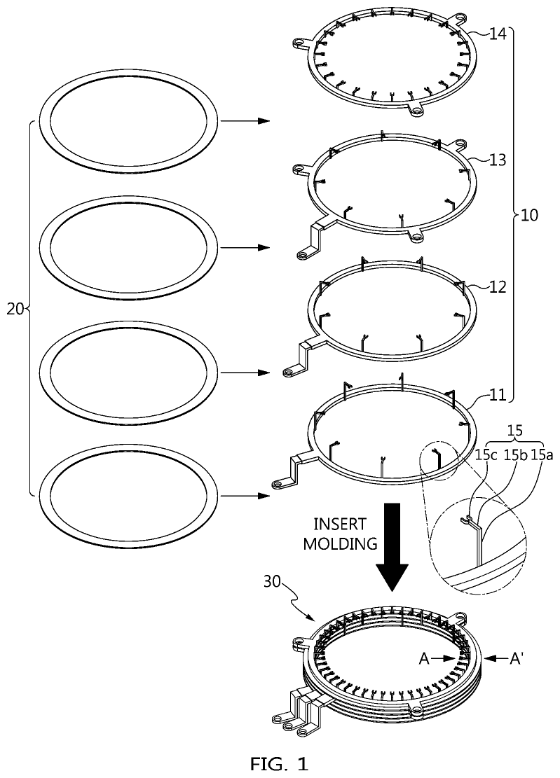

FIG. 1 is a drawing showing the coil wiring unit of a drive motor for a vehicle according to an exemplary embodiment of the present disclosure. As shown in FIG. 1, a coil wiring unit 30 of a drive motor for a vehicle (hereinafter, referred to as a “coil wiring unit”) according to an exemplary embodiment of the present disclosure is a coil wiring structure that connects coils drawn from split cores to each phase (i.e., U/V/W/N-phase) in a three-phase drive motor of a concentrated winding type and forms an annular bus bar having the same inner/outer diameter based on the concentric axis by each phase to stack them in the longitudinal (axial) direction.

The coil connection unit 30 may include a bus bar assembly 10 as an assembly structure of a plurality of bus bars that connects coils drawn out from the split core to each phase (i.e., U/V/W/N-phase) and a plurality of insulating sheets 20 inserted for insulation between the bus bars of the bus bar assembly. The bus bar assembly 10 may include a first to fourth bus bars 11, 12, 13, and 14, respectively, of an annular structure that may be manufactured individually and the first to fourth bus bars 11, 12, 13, 14 may have the same inner/outer diameters with respect to the concentric axis. Herein, the first bus bar 11 may be a U-phase bus bar, the second bus bar 12 may be a V-phase bus bar, the third bus bar 13 may be a W-phase bus bar and the fourth bus bar 14 may be an N-phase bus bar.

The first to fourth bus bars 11, 12, 13 and 14 may be made of copper (Cu) material and manufactured through a press process. Since the shapes of bus bars on each phase are the same, it may be possible to produce products with one mold. Further, the thicknesses of the first to fourth bus bars 11, 12, 13 and 14 may be matched to the material thickness of the press process according to the motor specification (continuous current, etc.). The first to fourth bus bars 11, 12, 13 and 14 each have connecting pieces 15 for connecting to each phase of the coil drawn from the split core.

Herein, each of the connecting pieces 15 may include a protruded portion 15a that protrudes in the longitudinal direction (axial direction) from the first to fourth bus bars 11, 12, 13 and 14, a bent portion 15b bent in the transverse direction (radial direction) at the end of the protruded portion 15a, and a groove portion 15c having a “U”-shaped groove in the bent portion 15b. The protruded portion 15a may be disposed at different positions to be connected to the first to fourth bus bars 11, 12, 13 and 14 based on each phase and may protrude at different lengths based on the first to fourth bus bars 11, 12, 13 and 14. In other words, each protruded portion may be disposed at a different position based on the phase.

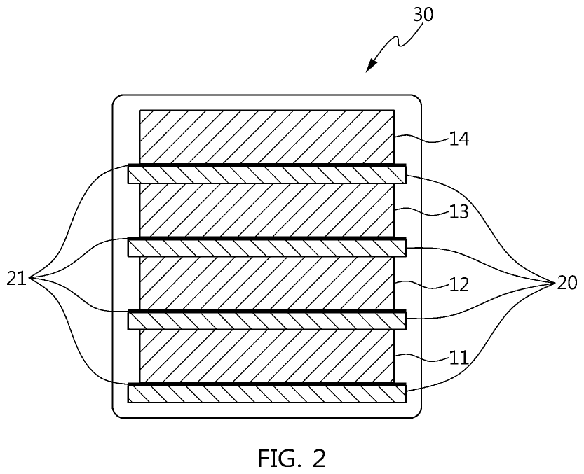

The plurality of insulating sheets 20 may be inserted for insulation between the first to fourth bus bars 11, 12, 13 and 14 of the bus bar assembly 10. In other words, each of a plurality of insulating sheets 20 may be disposed between the first bus bar 11 and the second bus bar 12, between the second bus bar 12 and the third bus bar 13, between the third bus bar 13 and the fourth bus bar 14, and at a lower portion of the fourth bus bar 14. Herein, the insulating sheets 20 may be selectively inserted at the lower portion of the fourth bus bar 14. The insulating sheets 20 may be attached to each of the first to fourth bus bars 11, 12, 13 and 14 during injection molding of the bus bar assembly 10 and then, disposed in a longitudinal direction injection mold or disposed in a longitudinal direction injection mold not being attached to each of the first to fourth bus bar 11, 12, 13 and 14. This will be described later with reference to FIG. 2 to FIG. 5.

Further, the insulating sheets 20 may be formed in an annular shape that corresponds to each of the bus bars of the bus bar assembly 10. The areas of the insulating sheets 20 may be equal to or greater than the area of each bus bar. A polymeric polymer series film such as PPS (Poly Phenyl Sulfide), PPA (Poly Phthal Amide) or PA66 (Polyamide 66) may be applied to the insulating sheets 20. In particular, NOMEX, PEEK (Polyether Ether Ketron), NPN (Nomex-Polyester-Nomex) series film may be applied to the insulating sheets 20. When comparing the insulation performance of these materials based on IEC 60250, PPS is 16 and NOMEX is 63 in the case of insulation breakdown voltage (kV/mm), and PPS is 1×10¹⁶ and NOMEX is 6×10¹⁶ in the case of volume resistance (Ω·cm). Conventional spacers may include polymeric polymer series material. In other words, the insulating sheets 20 using NOMEX series films improve insulation performance more than 3 times when considering insulation breakdown voltage as a criterion as compared with spacer using PPS.

In addition, the thickness of the insulating sheets 20 may be changed based on the operational voltage. For example, the insulating sheets 20 may have the thickness of about 0.2-0.3 mm level when the operating voltage is about 300 V. Considering that the thickness of the conventional spacer is 1.5 mm level, it may be possible to reduce the total length of the insulating sheets 20 by about 3-4 mm. However, since the bus bar assembly 10 is provided in the longitudinal direction (axial direction), one type of the insulating sheets 20 is sufficient. However, when the bus bar assembly 10 is provided in the transverse direction (radial direction), the inner/outer diameters of the first to fourth bus bars are different, and thus, the size of the insulating sheets 20 should also be changed. In other words, three types of specifications of the insulating sheets 20 are required. Of course, when the bus bar assembly 10 is disposed in the transverse direction (radial direction), the coil wiring unit 30 may be constructed using three types of insulating sheets 20.

Similarly, the coil wiring unit 30 may be formed by stacking the bus bar assembly 10 and the insulating sheets 20 and then integrally molding by insert molding. As a result, the coil wiring unit 30 may be molded without unformed or unfilled portions through an insert molding. Herein, the insert molding may take advantage of a molding material of polymeric polymer series, or a Bulk Molding Compound (BMC). Thus, the coil wiring unit 30 may be integrated with the stacking structure of the bus bar assembly 10 and the insulating sheet 20 by the insert molding, thereby reducing the number of components and simplifying the manufacturing process.

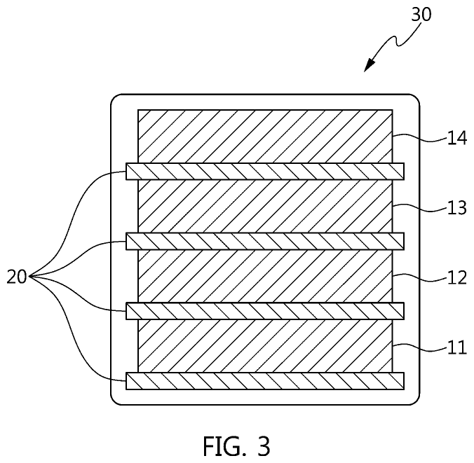

FIG. 2 to FIG. 5 are cross-sectional views taken along the line A-A′ in the coil wiring unit of FIG. 1. The coil wiring unit 30 shown in FIG. 2 and FIG. 3 may be molded into the entire injection molding product at once through the insert molding by inserting the insulating sheet 20 between each bus bar when stacking the first to fourth bus bars 11, 12, 13 and 14 and disposing the insulating sheet 20 in the injection mold.

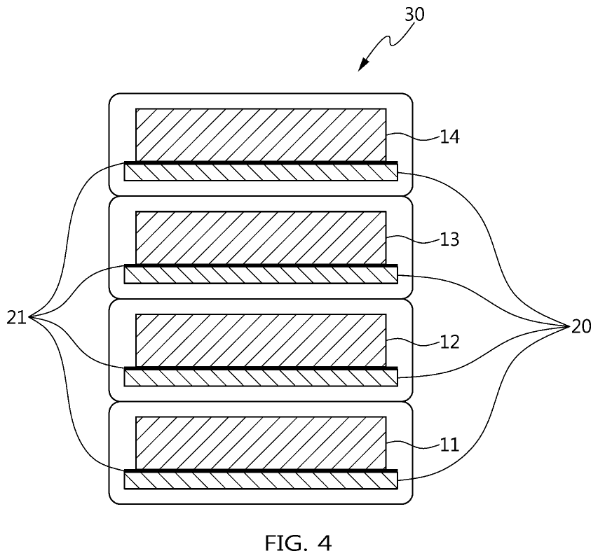

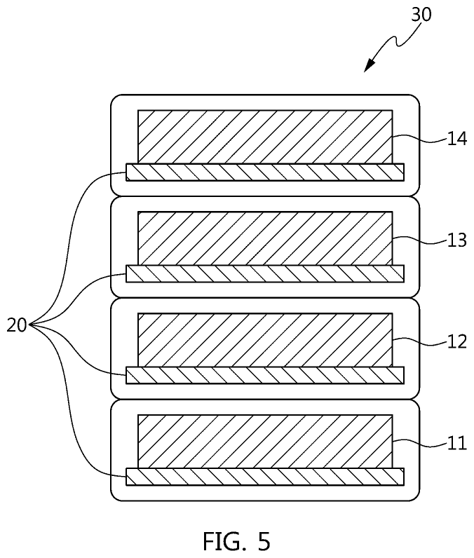

Moreover, the coil wiring unit 30 shown in FIG. 4 and FIG. 5, may be molded into the entire injection molding product by inserting the insulating sheet 20 into each bus bar when stacking the first to fourth bus bars 11, 12, 13 and 14, and disposing the insulating sheet 20 in the injection mold to mold it into an individual injection molding product through the insert molding, and then, assembling the individual injection molding product.

In particular, since each of the first to fourth bus bars 11, 12, 13 and 14 may be individually insulated via insert molding, the insulating sheet 20 may not be separately attached to each of the first to fourth bus bars 11, 12, 13 and 14. However, the insulating sheet 20 shown in FIG. 2 and FIG. 4 may be attached to each of the first to fourth bus bars 11, 12, 13 and 14 using an adhesive 21, and the insulating sheet 20 shown in FIG. 3 to FIG. 5 is not attached to each of the first to fourth bus bars 11, 12, 13 and 14 and may be disposed at the related position.

Additionally, the coil wiring unit 30 may be molded by stacking the first to third bus bars 11, 12 and 13 and molding all the first to third bus bars at once through the insert molding, molding the fourth bus bars 14 individually through insert molding, and then, by integrally stacking the molding product of the first to third bus bars 11, 12 and 13 and the molding product of the fourth bus bar 14. Similarly, the above-described insert molding methods may be used by mixing each other. In other words, the exact combination of the bus bars as described above may be changed.

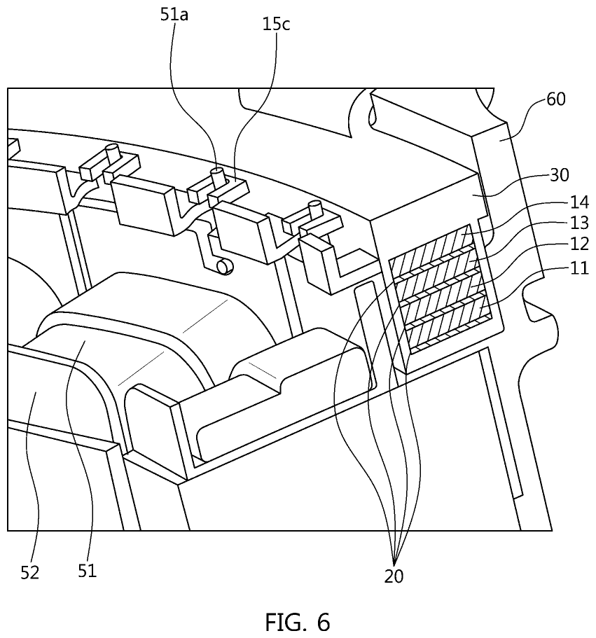

FIG. 6 shows a cross sectional view of the coil wiring unit of the FIG. 1 installed at a drive motor. Referring to FIG. 6, in the concentrated winding type three-phase drive motor, a coil 51 of each phase may be wound on a bobbin 52 that surrounds a split core along a transverse (radial) direction inside. Herein, the end portion 51a of the coil 51 may be coupled to the groove portion 15c formed in the connecting piece 15 of the coil wiring unit 30. In other words, a circumferential surface of the end portion 51a of the coil 51 may be surrounded by the inner surface of the groove portion 15c of the “U”-shape and coupled thereto through fusion welding.

Additionally, the coil wiring unit 30 may be fitted to and mounted on an outer frame 60 of the drive motor through the inserting molding. Thus, the groove portion 15c formed in the connecting piece 15 may be coupled to the end portion 51a of the coil 51 even though the process of separately aligning the coil wiring unit 30 with the end portion 51a of the coil 51 is not considered. Further, the coil wiring unit 30 may be mounted on the drive motor since the insulating sheets 20 may be inserted and attached between the first to fourth bus bars 11, 12, 13 and 14 to be stacked and modularized through the insert molding. The coil wiring unit 30 may be attached and detached from the other components of the drive motor and thus may be maintained and repaired by the operator more easily.

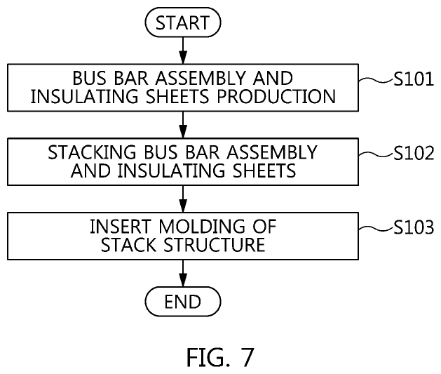

FIG. 7 is a drawing illustrating a manufacturing method of a coil wiring unit for a drive motor of a vehicle according to an exemplary embodiment of the present disclosure. In step S101, the bus bar assembly 10 of the coil wiring unit 30 applied in the concentrated winding type three-phase drive motor may be manufactured through the press process, and the insulating sheets 20 may be manufactured by the shape corresponding to the bus bar assembly 10. Herein, since each bus bar assembly 10 may have the same inner/outer diameter, it may be possible to produce product with one mold.

Each of the insulating sheets 20 may be formed into a shape that corresponds to the bus bar assembly 10. The area of the insulating sheet 20 may be greater than or equal to the area of the bus bar assembly 10. In step S102, the bus bar assembly 10 and the insulating sheets 20 may be stacked. In other words, the insulating sheets 20 may be inserted between each bus bar assembly 10 to ensure the insulating property. In step S103, the stacking structure of the bus bar assembly 10 and the insulating sheets 20 may be integrally formed through the insert molding. Herein, each of the bus bar assembly 10 and the insulating sheets 20 may be subjected to the insert molding individually, and then assembled into one module, or may be formed into a single module by performing the insert molding as a whole.

Although the description has been described with a focus on novel features of the present disclosure that apply to various exemplary embodiments, those skilled in the art will appreciate that various deletions, substitutions, and alterations are possible in the form and detail of the apparatus and method described above without departing from the scope of the present invention. Accordingly, the range of the present disclosure is defined by the appended claims rather than the description. All variants within the even scope of the claim scope are included in the scope of the present disclosure.

What is claimed is:

1. A coil wiring unit of a drive motor for a vehicle, comprising:
a bus bar assembly having a plurality of bus bars for connecting coils of the drive motor to each phase, wherein the bus bars are stacked in a longitudinal direction; and
a plurality of insulating sheets which correspond to the shape of each of the bus bars of the bus bar assembly and disposed between each of the bus bars of the bus bar assembly.

2. The coil wiring unit of the drive motor for the vehicle of claim 1, wherein each of the bus bars is an annular structure having the same inner/outer diameter based on the concentric axis.

3. The coil wiring unit of the drive motor for the vehicle of claim 1, wherein each of the bus bars is a conduct plate of copper material formed through a press process.

4. The coil wiring unit of the drive motor for the vehicle of claim 1, wherein each of the bus bars includes a connecting piece to connect the coils of the drive motor to each phase.

5. The coil wiring unit of the drive motor for the vehicle of claim 1, wherein the connecting piece includes:
a protruded portion that protrudes from each of the bus bars in a longitudinal direction;
a bent portion bent from an end portion of the protruded portion in a transverse direction; and
a groove portion having a U-shaped groove at the bent portion.

6. The coil wiring unit of the drive motor for the vehicle of claim 5, wherein the protruded portion is disposed at different positions to be connected to each of the bus bars based on each phase and has different protruding lengths according to each of the bus bars.

7. The coil wiring unit of the drive motor for the vehicle of claim 1, wherein an area of each of the plurality of insulating sheets is greater than or equal to an area of each of the bus bars.

8. The coil wiring unit of the drive motor for the vehicle of claim 1, wherein each of the plurality of insulating sheets is a NOMEX, PEEK (PolyEther Ether Ketron), NPN (Nomex-Polyester-Nomex) series film.

9. The coil wiring unit of the drive motor for the vehicle of claim 1, wherein the bus bar assembly and the plurality of insulating sheets are all stacked and then integrally formed through an insert molding.

10. The coil wiring unit of the drive motor for the vehicle of claim 9, wherein each of the plurality of insulating sheets is attached to each of the bus bars using an adhesive.

11. The coil wiring unit of the drive motor for the vehicle of claim 1, wherein each of the bus bars and each of the plurality of insulating sheets are individually stacked and then formed into an individual molding product through an insert molding; and each of the individual molding product is stacked into one piece to be assembled.

12. The coil wiring unit of the drive motor for the vehicle of claim 11, wherein each of the plurality of insulating sheets is attached to each of the bus bars using an adhesive.

13. A manufacturing method of a coil wiring unit of a drive motor for a vehicle, comprising:
forming a bus bar assembly having a plurality of bus bars for connecting coils of a drive motor to each phase stacked in a longitudinal direction, and a plurality of insulating sheets which correspond the shape of each of the bus bars and disposed between each of the bus bars;
stacking the bus bar assembly and the plurality of insulating sheets; and
stacking the bus bar assembly and the plurality of insulating sheets and then integrally molding the bus bar assembly and the plurality of insulating sheets through an insert molding.

14. The manufacturing method of the coil wiring unit of the drive motor for the vehicle of claim 13, wherein the stacking the bus bar assembly and the plurality of insulating sheets includes:
attaching each of the plurality of insulating sheets to each of the bus bars using an adhesive.

15. A manufacturing method of a coil wiring unit of a drive motor for a vehicle, comprising:
forming a bus bar assembly having a plurality of bus bars for connecting coils of a drive motor to each phase stacked in a longitudinal direction, and a plurality of insulating sheets which correspond the shape of each of the bus bars and disposed between each of the bus bars;
stacking the bus bar assembly and the plurality of insulating sheets individually and then forming an individual molding product through an insert molding; and
stacking each of the individual molding product to one piece.

16. The manufacturing method of the coil wiring unit of the drive motor for the vehicle of claim 15, wherein the stacking the bus bar assembly and the plurality of insulating sheets includes:
attaching each of the plurality of insulating sheets to each of the bus bars using an adhesive.
